(19) United States
(12) Patent Application Publication
(10) Pub. No.: US 2011/0287181 A1
(43) Pub. Date: Nov. 24, 2011

(54) METHOD FOR PRODUCING NANOSTRUCTURES BY MEANS OF SPINODAL DECROSSLINKING

(76) Inventors: Franz Faupel, Heikendorf (DE); Rainer Adelung, Kiel (DE); Mady Elbahri, Kiel (DE); Khaled Hirmas, Kiel (DE)

(21) Appl. No.: 12/741,905

(22) PCT Filed: Nov. 4, 2008
(86) PCT No.: PCT/DE2008/001801

§ 371 Date: Apr. 15, 2011

(30) Foreign Application Priority Data
Nov. 8, 2007 (DE) 10 2007 053 157.7

(51) Int. Cl. B05D 3/02; B05D 3/10

(52) U.S. Cl. 427/229; 427/226

(57) ABSTRACT

Disclosed is a method for producing regularly arranged nanowires from a nanowire-forming material on a substrate. Said method is characterized by the following steps: a) the material is introduced into a carrier liquid at a load remaining at least three orders of magnitude below the loading capacity of the carrier liquid; b) a guiding member is placed on the substrate; c) the substrate is heated to a temperature at which a thin film of the carrier liquid undergoes spinodal decrosslinking on the substrate; d) a film of the carrier liquid that is loaded with material is applied to the heated substrate in the surroundings of the guiding member, where a gradient of the average film thickness is obtained perpendicular to the contour of the guiding member; and e) the carrier liquid is evaporated such that the material is left along lines extending perpendicular to the gradient of the film thickness.

The invention relates to a method for producing nanowires and nanowire grid structures that are arranged in a regular pattern.

The reproducible production of nanoscale structures is in the focus of present research, among others, because a multitude of applications can be envisaged for device fabrication, for example in the areas of photonics and electronics, sensor technology and biotechnology (e.g. lab-on-chip). Known physical structuring methods such as lithography can be employed for the nanometer scale only to a limited extent and are also complex and expensive. Self-organizing structure formation (“self assembly”) from nanoparticles has of late received more attention, which however will not necessarily lead to technically usable, in particular regular structures.

According to the view, that is now being widely held, the key for mass production of nanostructures lies in the development of suitable control methods that so to say provide the self-organized structure formation with “the desired direction”. Further phenomena of nano self-structuring are at the same time still being discovered and investigated as to whether they offer a favorable starting point for such a control method.

Such a phenomenon can be observed during evaporation or slow vaporization of a drop of a colloidal suspension on a substrate. After the solvent has been removed completely, typical annular deposits of the colloidal material form as a remainder on the substrate. Interestingly, an arrangement of largely separate rings of the colloidal material is formed in this way and precisely not a planar distribution, as a naïve person might expect.

To explain this phenomenon, that is also called the “coffee stain effect”, Deegan explains in his dissertation “DEPOSITION AT PINNED AND DEPINNED CONTACT LINES: PATTERN FORMATION AND APPLICATIONS” (University of Chicago, 1998) that the limiting contact line of the suspension drop—that is to say the course of the drop edge—is fixed (“pinned”) on the substrate by impurities even during evaporation. This leads to a build-up of colloidal particles along the contact line, which again even leads to a reinforcement of the fixing (“self-pinning”) and to a transport of further suspension to the contact line. In this way, particles concentrate at the contact line until transport breaks down. The drop that has been reduced in the meantime, but still exists, contracts in the process practically with a jump, that is to say it forms a new contact line to the substrate that now lies more closely, and the processes repeat there. Finally, several more or less concentric rings from colloidal material can be found after the solvent has evaporated completely.

The phenomenon described is also called nanostructuring by “contact line pinning” in the literature. However, the structures that are found usually have a width of a few micrometers even if they emerge from nano-scale constituents. In addition, due to round drop-contact lines, they are in principle annular and do not form regular patterns just like that. Also a colloidal suspension is a precondition for a successful “contact line pinning”.

An example for manufacturing parallel wires using such a method can be gathered from the paper by Huang et al., “One-Step Patterning of Aligned Nanowire Arrays by Programmed Dip Coating” (Angew. Chem. Int. Ed. 2007, 46, 2414-2417). In the process, a vertically oriented substrate is pulled from a particle suspension at a defined velocity, so that particles accumulate along a straight contact line to form a linear structure. Pulling out the substrate—like the drying drop—progressively thins the suspension film that adheres to the substrate and is fixed to the contact line, until suddenly a new contact line is assumed in a jump that lies deeper. As a result, an arrangement is produced on the substrate of parallel, equally spaced wires whose spacing can be controlled via the pulling-out velocity.

Here again, a disadvantage of this method resides in the considerable structural widths of a few micrometers. In addition, it is doubtful whether in this way even intersecting wires or even whole grids can be produced—for example by rotating the substrate about an angle and repeating the entire procedure—, since the wires that are then already present could interfere with the course of the wetting boundary of the suspension, in particular impede the fixing of the contact line. Anyway, the authors of the article that has been cited do not say anything on grids, even though their production using their method positively suggests itself.

The paper by Padmakar et al., “Instability and dewetting of evaporating thin water films on partially and completely wettable substrates” (J. Chem. Phys., Vol. 110, 1735-1744, 1999) presents an explanation for a different structuring phenomenon when aqueous drops or films evaporate.

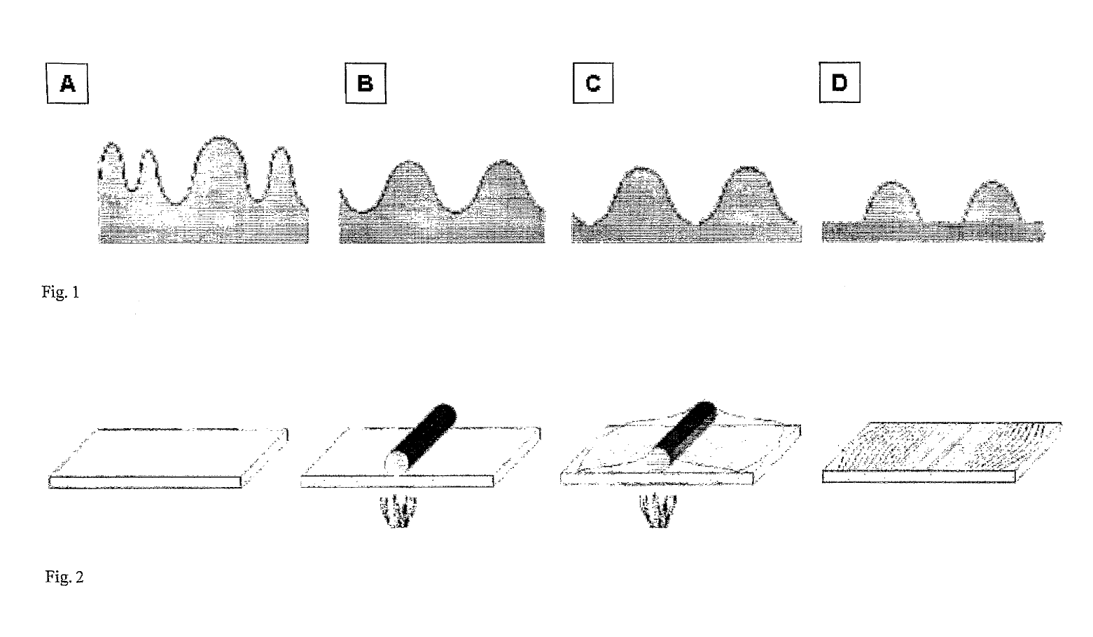

An aqueous thin film in principle has a certain roughness on its surface, that is to say the actual film thickness is a function h(r, t), r being a space coordinate along the substrate and t being the time. The variation of the film thickness Δh is temperature-dependent and can reach the order of magnitude of the decreasing mean film thickness <h>(t)=∫h(r, t) dr during the evaporation of the film. Even without going into more detail with respect to the theoretical discussion of Padmakar et al., it is readily obvious that the film can turn unstable in the process. In practice, holes can develop in the film that reach up to the substrate, and the film thickness can assume a largely periodic structure. These holes can be the starting points for a separation of “residual film pieces”—and thus lead to the formation of droplets (see FIG. 1 as an illustration). Thereafter the droplets evaporate separately from each other and independently. In the professional world, this phenomenon of spontaneous regular decrosslinking of thin films which cannot only be observed with water, but above all with organic liquid films, but also on liquefied metal films, is known as “spinodal decrosslinking” or “spinodal dewetting”. A more precise physical explanation can be found among others in the paper by Jacobs and Herminghaus, “Strukturbildung in dünnen Filmen”, Physikalische Blätter, 55 (1999), No. 12.

The paper by Padmakar et al. shows that there are characteristic lengths for the subdivision of the film that are a function in particular of the velocity of the evaporation. It thus shows a way for regular film structuring even without the involvement of colloids and gives some clues as to the control of structural parameters by means of the temperature.

Even in the paper by Weiss, “To Bead or Not to Bead?” (Science News, Vol. 155, p. 28, 1999) reference is made to the view that spinodal decrosslinking be suitable for producing patterns and structures (for example from nanoparticles) on substrates whose dimensions are actually on the scale of nanometers.

The dissertation by Rath, “Periodisch angeordnete photochrome Dots für hochdichte optische Speicher”, Universität Stuttgart, 2007, describes the production of quantum dots of uniform size (diameter of several 10 up to a few 100 nm) in a strictly periodic arrangement by means of spinodal decrosslinking. This however does not succeed on a flat substrate where only dots of different sizes form in a random distribution. Rath therefore employs pre-structured substrates provided with trenches.

For the prior art, reference is further made to K. Kargupta, A. Sharma: “Creation of Ordered Patterns by Dewetting of Thin Films on Homogenous and Heterogenous Substrates”, Journal of Colloid and Interface Science, Volume 245, pp. 99-115 (2002) and A. M. Higgins and R. A. L. Jones: “Anisotropic spinodal dewetting as a route to self-assembly of patterned surfaces”, Nature 404, pp 476-478 (2000). Starting from the mentioned prior art, the invention now sets itself the object of specifying a simple method for producing nanowire structures, in particular of nanogrids, where the produced structural widths of the individual nanowires that have been produced are in the order of magnitude of 100 nanometers.

The object is achieved by a method according to Claim 1. The sub-claims specify advantageous embodiments. The principle procedure of the invention is as follows:

The material forming the nanostructure is introduced into a carrier liquid, care has to be taken that no essential amounts of the material can be set free directly after the evaporation of the carrier liquid has set in. The loading of the carrier liquid therefore has to clearly remain below the loading capacity.

The carrier liquid loades with a material is applied onto a flat material that has not been structured in advance, so that a liquid film forms on the substrate.

The thickness of the liquid film h(r, t) is not uniform but varies along the substrate surface even in terms of its local mean value <h>(r₀, t)=∫_{Ω}h(r, t) dr, the averaging integral extending over a small surroundings Ω around the point r₀. Inventive measures have to be taken so as to set up the gradient ∇ᵣ₀<h>(r0, t) as uniform as possible over larger surface areas of the substrate, but at least as parallel as possible.

The substrate that has been wetted by a film is brought as uniformly as possible to an increased temperature below the boiling point of the carrier liquid so that it evaporates rapidly while forming a considerable surface roughness. As a result, the film thickness decreases rapidly everywhere, but only in this part area of the wetted surface with a “matching” film thickness a spinodal decrosslinking and thus a structuring of the film develops. The area of matching film thickness “migrates” across the substrate as the evaporation progresses. The course of the structure shows itself as perpendicular to the respective local gradient of the film thickness ∇ᵣ₀<h>(r0, t).

When the entire carrier liquid has evaporated, the material forming the nanostructure remains predominantly—and very selectively, as can be seen—on those surface areas that were the last to be wetted when the spinodal decrosslinking sets in. The structural widths are very small and the structures run parallel in particular where a large range with parallel film-thickness gradients was present.

The structures that have been produced are relatively robust to post-processing. It has in particular been found to be possible to process again substrates with such structures using the method described above, it also being possible to change the direction of the film-thickness gradient. In this way, precise grid structures can be produced very easily.

A few explanations and detailed definitions follow:

The spinodal decrosslinking of the carrier liquid that is provided according to the invention effects a structuring of the liquid film in principle independently of the edges of the liquid. However, in each application in practice the carrier liquid will be limited (for example a drop of the carrier liquid is applied to the substrate), so that these edges influence the structure. In addition, an influence results on the spinodal structuring if colloidal particles for forming the nanostructure are added to the carrier liquid, since then “contact line pinning” sets in, as is known.

The present invention can be applied to colloidal suspensions, but also to saline solutions where the mechanism of “contact line pinning” does not apply, since on evaporation, structures only form on the substrate if practically no more long-distance material transport to these structures is possible.

To clarify the potential of the invention, the exemplary embodiment that is used and that at the same time implements a preferred design of the invention, a saline solution is used for producing structures. In this case the carrier liquid is water. Practically any water-soluble salt can be used for forming the nanostructures, however there is presently of course no significant interest in salt nanowires. For this reason, silver nitrate (AgNO₃) is preferably used, since it is known that silver nitrate disintegrates into nitrogen oxide (NO₂), oxygen and elemental silver when treated thermally. The aim of the example is therefore the production of parallel silver wires and silver grids.

When loading the water with silver nitrate, care has to be taken to stay clearly below the solubility limit, preferably by a factor of 10⁻³ to 10⁻⁶. If a solution were to be prepared close to the solubility limit, silver nitrate precipitates would be produced directly after the water starts to evaporate that do not orient themselves according to the spinodal decrosslinking. If on the other hand the solution is prepared with too weak a concentration, then salt nanowires having the expected structure develop, however they are interrupted because of a lack of sufficient material. In the specific exemplary embodiment, a 10⁻⁵ mol silver nitrate solution is used (solubility 12.7 mol/l at 20° C.:).

The loaded carrier liquid is dropped on a substrate that has not been pre-structured—in this case a silicon wafer. It is already known from Rath (2007) and confirmed by further research that trench structures that are present strongly influence the structuring by spinodal decrosslinking. Therefore it is shown here which inventive measures can be used to control structuring even on a flat smooth substrate.

The invention is explained in more detail using the following figures, in which:

FIG. 1 shows a schematic representation of the development of spinodal decrosslinking;

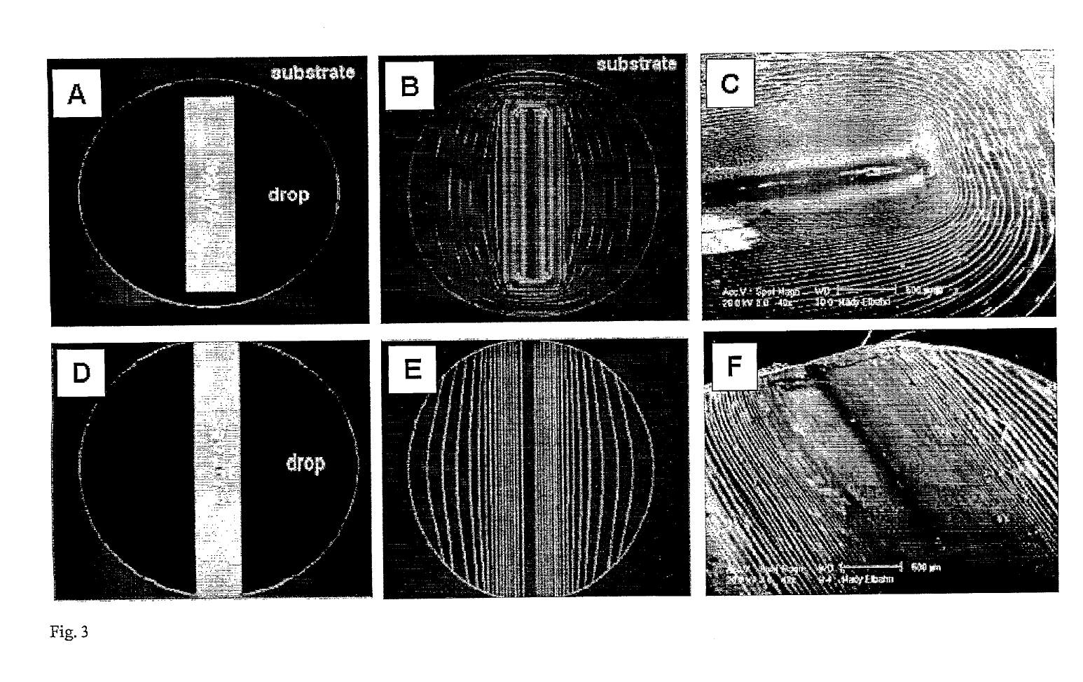

FIG. 2 shows a specific design of setting up a film-thickness gradient pointing in the desired direction with the structures achieved thereby;

FIG. 3 shows a representation of the nanostructures that have been achieved, with a guiding member (cylinder) on the substrate and a diagram of the experimental setup and the expected result;

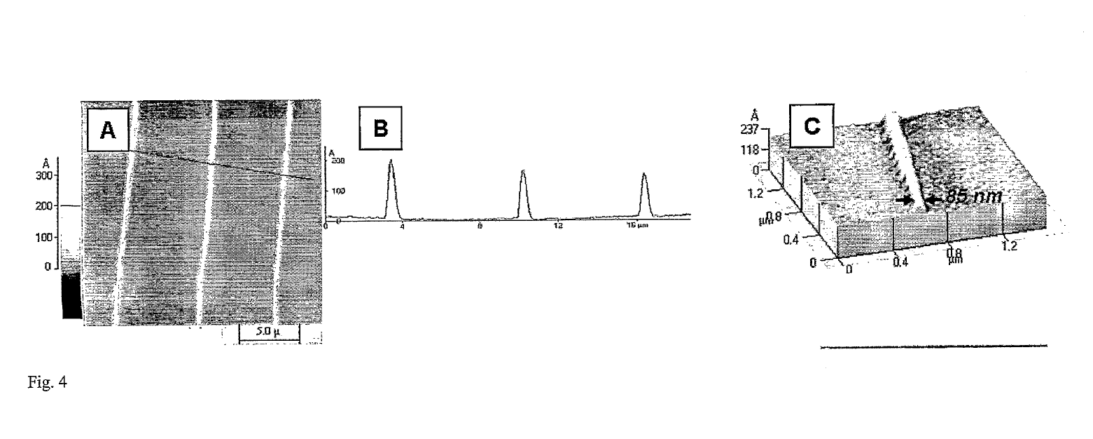

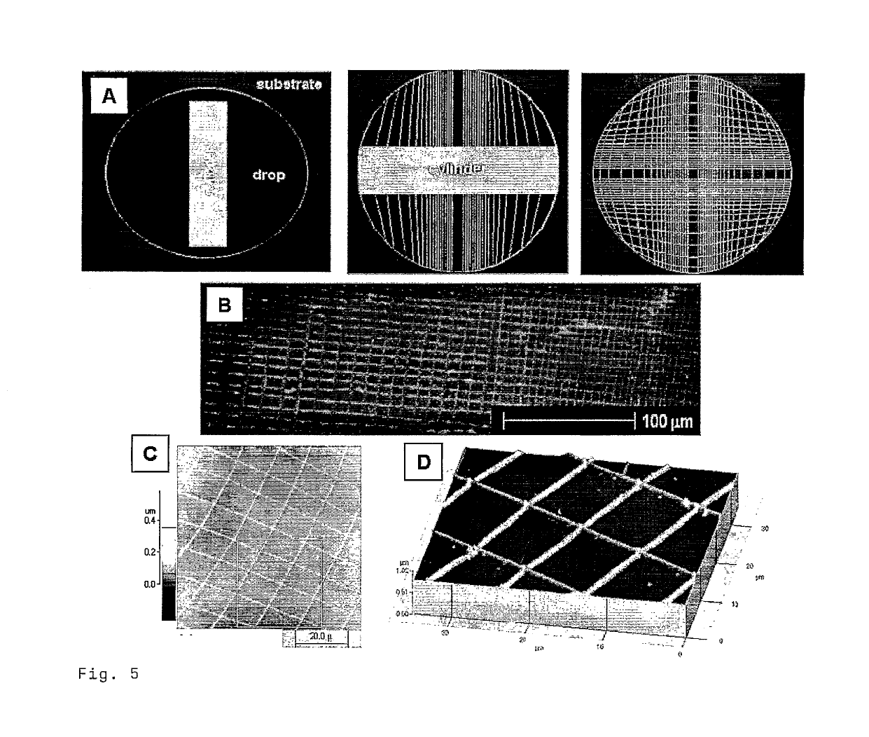

FIG. 4 shows force-microscope images of the nanowires (A) produced with a line scan (B) along the line shown in A and a detail (C);

FIG. 5 shows a schematic representation of the approach for producing nanogrids (A), a scanning-electron-microscope image of a grid (B) that has been produced and force-microscope images of grid details (C, D).

FIG. 1 represents the known spinodal decrosslinking for liquid thin films. Their appearance is governed by the production of a periodic roughness of the fluid surface in the order of magnitude of the film thickness. Padmakar et al. show that even an extensive evaporating water film tends to form regular structures whose distances relative to each other are predetermined by the capillary wavelength that in turn is a function of the evaporation rate of the water.

In the present invention, the evaporation rate is controlled via the substrate temperature. If water is the carrier liquid, the substrate temperature should preferably be set between 50° C. and 80° C. Since local temperature gradients in the substrate can likewise contribute to influencing the development of spinodal decrosslinking, they shall preferably be avoided here. Therefore the substrate is preheated to a raised temperature (for example in an oven) so that a constant temperature of the substrate can be assumed even before the dripping.

FIG. 2 shows how placing a guiding member (in this case a glass cylinder having a diameter of 1.5 mm and a length of 8 mm, in the following referred to as guide) on the preheated substrate specifies how nanostructuring takes place. When the loaded carrier liquid is dripped onto the substrate, the guide has an attracting effect on the liquid as a result of the known adhesion. A film-thickness gradient is established that is aligned along the guide perpendicularly to its course. When the film is evaporated, narrow areas form at first in which spinodal decrosslinking appears, in the edge area of the drop with a roughly annular characteristic. As evaporation progresses, these areas approach the guide and their form is increasingly dominated by the shape of the guide. Deposits (here: salt nanowires) are formed as residues of the evaporated fluid and exhibit a high degree of regularity and imitate the contour of the guide. With decreasing distance from the guide, the nanowires are increasingly more dense, that is to say the capillary wavelength decreases as the evaporation progresses. It seems as if the amount of the local gradient of the film thickness that is largest directly at the guide determines the thickness of the nanowires. In any case, it determines the width of the area of the spinodal decrosslinking at a specified time.

FIG. 3 shows the experimental results of implementing the setup from FIG. 2. Here the sketches A and D clarify the difference between the upper and lower image row that consists in whether the guide penetrates the drop edge or not. The images B and E show the expectation which nanostructures should develop, and C and F show clearly that this expectation is delivered very well.

Exceedingly important are the very small dimensions of the structures in the direct vicinity of the guide. FIG. 4 shows a detail of these structures, taken with the force microscope. The uniformity of the wires and their spacings can be seen clearly in image A. A sectional measurement along the line in image A, shown as image B, shows here that the wires in each case have a height of approximately 2 nm and that this height decreases with the distance from the guide. Finally, image C shows that the wires that have been produced exhibit a diameter of about 100 nm, which was the object of the invention.

So that grid structures can now be achieved, according to the invention one can proceed in a very simple way, as FIG. 5 proves. After a first nanowire arrangement has been produced as described above, the guide is simply rotated through an angle of for example 90° and the procedure is repeated. To this end, it is not necessary to fixate the structures produced in the first pass, that is to say salt nanowires can remain. They are by no means dissolved again by the second wetting process. FIG. 5 A shows a diagram and an expected result of this procedure.

FIG. 5 B shows a scan-electron-microscope image of the almost regular grid structure that then develops. In this large-scale image (approximately 0.4 mm wide), the phenomenon of the changing capillary wavelengths and thus the structure spacings is clearly visible.

The force-microscope images in FIG. 5 C clarify impressively the regularity and the perfection of the nanogrids, where virtually no material was deposited beside the grid lines.

The behavior of the nanowire arrangements at the intersections seems completely without any interference, that is to say the presence of the first wires has evidently in no way interfered with the production of the second wires. This substantiates the hope that even structures that are much more complex and that demand a multiplicity of separate wetting processes can be produced with a high-quality result.

In addition, it should be stressed that the choice of a linear guide for placing on the substrate was a completely arbitrary one. Of course, the guide can also be randomly bent or even have corners, and it will result in nanowire arrangements that imitate its shape in its immediate surroundings (even though the corners will of course appear rounded). In particular it is certainly to be preferred for the purposes of a production for example on industrial levels, to use not only a single guide but an appropriate arrangement of several guides (for example a grid window or the like).

As has already been mentioned, the industry is more interested in metallic wires. The method described above is therefore terminated by heating the substrate that has been provided with nanostructures to temperatures of about 200° C. All images shown here represent the silver structures that have already been produced. When using the invention, one will surely preferably concentrate on salts that permit a comparatively simple transition into a metal.

1. A method for producing regularly arranged nanowires from a nanowire-forming material on a substrate, characterized by the following steps:
a. the material is introduced into a carrier liquid at a load remaining at least three orders of magnitude below the loading capacity of the carrier liquid,
b. a guiding member is placed on the substrate,
c. the substrate is heated to a temperature at which a thin film of the carrier liquid undergoes spinodal decrosslinking,
d. a film of the carrier liquid that is loaded with material is applied to the heated substrate in the surroundings of the guiding member, where a gradient of the average film thickness is obtained perpendicular to the contour of the guiding member, and
e. the carrier liquid is evaporated such that the material is left along lines extending perpendicular to the gradient of the film thickness.

2. The method according to claim 1 for producing intersecting nanowire arrangements; characterized by repeating the steps a-e at least once while in each case rotating the guiding member through an angle.

3. The method according to claim 1, characterized in that the nanowire-forming material consists of colloidal particles that are suspended in the carrier liquid.

4. The method according to claim 3, characterized in that nanoparticles from a noble metal are used as colloidal particles.

5. The method according to claim 1, characterized in that the nanowire-forming material is a salt that is dissolved in the carrier liquid.

6. The method according to claim 5, characterized in that noble-metal salts are used.

7. The method according to claim 6, characterized in that silver nitrate is used.

8. The method according to claim 7, characterized in that the nanowires produced from silver nitrate are transferred into elemental silver by thermal post-treatment at about 200° C.

9. The method according to claim 1, characterized in that a silicon wafer is used as the substrate.

10. The method according claim 1, characterized in that the guiding member is an arrangement of rods having at least one flat side that is placed on the substrate.

11. The method according to claim 1, characterized in that a single glass cylinder is used as a guiding member.

12. The method according to claim 1, characterized in that water is used as carrier liquid and the substrate is heated to temperatures of between 50° C. and 80° C.

13. The method according to claim 7, characterized in that a 10⁻⁵ mol silver nitrate solution is prepared and brought onto the substrate.

14. The method according to claim 12, characterized in that a 10⁻⁵ mol silver nitrate solution is prepared and brought onto the substrate.
